(19) United States
(12) Patent Application Publication
(10) Pub. No.: US 2005/0197944 A1
(43) Pub. Date: Sep. 8, 2005

(54) Separate trading of registered interest and principal of securities system, method and computer program product

(75) Inventor: Robert D. Arnott, Pasadena, CA (US)

Correspondence Address: VENABLE LLP, P.O. BOX 34385, WASHINGTON, DC, 20045-9998, US

(73) Assignee: Research Affiliates, LLC, Pasadena, CA (US)

(21) Appl. No.: 11/050,458

(22) Filed: Feb. 4, 2005

Related U.S. Application Data
(60) Provisional application No. 60/541,677, filed on Feb. 4, 2004.

(51) Int. Cl. G06F 17/60

(52) U.S. Cl. 705/35

(57) ABSTRACT

A method and apparatus for investing is set forth. Taking the present value of a future liability as the starting point, interest bearing securities or derivatives may be purchased that may have a duration less than that of the future liability, but are purchased in sufficient multiples of so that the duration of the investment, times the multiple, equals the duration of the future liability. The securities or derivatives of less duration will in almost all cases have associated interest rates that are less than that of a similar security or derivative whose duration matches that of the future liabilities. As duration decreases for the available securities or derivatives, interest rates of each will also decrease, but not as rapidly the rate of decrease in duration. By using leverage, securities or derivatives can be purchased in amounts such that the duration of the investment will match that of the future liabilities, but the total amount of interest available from the leveraged investment will exceed that for a similar instrument whose duration matches that of the future liabilities.

### CROSS-REFERENCE TO RELATED APPLICATION

The present application is a non-provisional application claiming priority to U.S. Provisional Patent Application No. 60/541,677 entitled, “Separate Trading of Registered Interest and Principal of Securities,” to Arnott, (Attorney Docket No. 43622-204085, formerly 51805/FLC/A750), filed Feb. 4, 2004, the contents of which is incorporated herein by reference in its entirety.

### BACKGROUND OF THE INVENTION

1. Field of the Invention

This invention pertains generally to securities investing and more specifically to investment in bonds, interest-bearing securities, and/or related derivatives.

2. Related Art

A bond is an investment which may have two components, periodic interest payments and repayment of principal. The repayment of interest may be through coupons associated with the bond. The principal payment and interest payment of the bond may be separated and sold individually. A bond that is traded without its coupons is called a “zero-coupon bond.” Separate trading of registered interest and principal of securities (STRIPS) refers to an instrument allowing an investor to hold and trade individual interest and principal components of bonds as separate securities. STRIPS are popular with investors who want to receive a known payment at a specific future date. For example, some State lotteries invest the present value of large lottery prizes in STRIPS to be sure that funds are available when needed to meet annual payment obligations that result from the prizes. Pension funds invest in STRIPS to match the payment flows of their assets with those of their liabilities to make benefit payments. STRIPS are also popular investments for individual retirement accounts, 401(k)-type savings plans, and other income tax-advantaged accounts that permit earnings to accumulate without incurring immediate income tax consequences.

### SUMMARY OF THE INVENTION

In accordance with an exemplary embodiment of the present invention, a net asset value of a particular investment, herein termed a correlated investment, may be aligned with a present value of a future liability, or stream of future liabilities, through matching the duration of the correlated investment to the duration of the future liability or stream of future liabilities. As the net asset value of the correlated investment is aligned to the present value of the future liability, the net asset value of the correlated investment may change in a highly correlated manner with changes in the present value of the future liability. In addition, the correlated investment may generate returns that are greater than the returns of a zero-coupon bond that matures at the same time that the future liability is due.

In another aspect of the invention, the present value of a stream of future liabilities may be determined by discounting the future value of the future liabilities to a present value. The discount rate which may be used to calculate the present value may be the yield of a zero-coupon Treasury bond, which matures at the same time as the future liabilities. As such, the present value of the future liabilities changes with the yield on the matched zero-coupon Treasury bond.

### BRIEF DESCRIPTION OF THE DRAWINGS

The foregoing and other features and advantages of the invention will be apparent from the following, more particular description of exemplary embodiments of the invention, as illustrated in the accompanying drawings. In the drawings, like reference numbers generally indicate identical, functionally similar, and/or structurally similar elements. The drawing in which an element first appears is indicated by the leftmost digits in the corresponding reference number. A preferred exemplary embodiment is discussed below in the detailed description of the following drawings:

FIG. 1 is a collaboration diagram of a correlated investment system in accordance with an exemplary embodiment of the present invention;

FIG. 2 is a process flow diagram of a correlated investment process in accordance with an exemplary embodiment of the present invention; and

FIG. 3 is a block diagram of a host suitable for hosting a correlated investment system in accordance with an exemplary embodiment of the present invention.

### DETAILED DESCRIPTION OF EXEMPLARY EMBODIMENTS OF THE INVENTION

Various exemplary embodiments of the invention are discussed in detail below including a preferred embodiment. While specific implementations are discussed, it should be understood that this is done for illustration purposes only. A person skilled in the relevant art can recognize that other components and configurations may be used without parting from the spirit and scope of the invention.

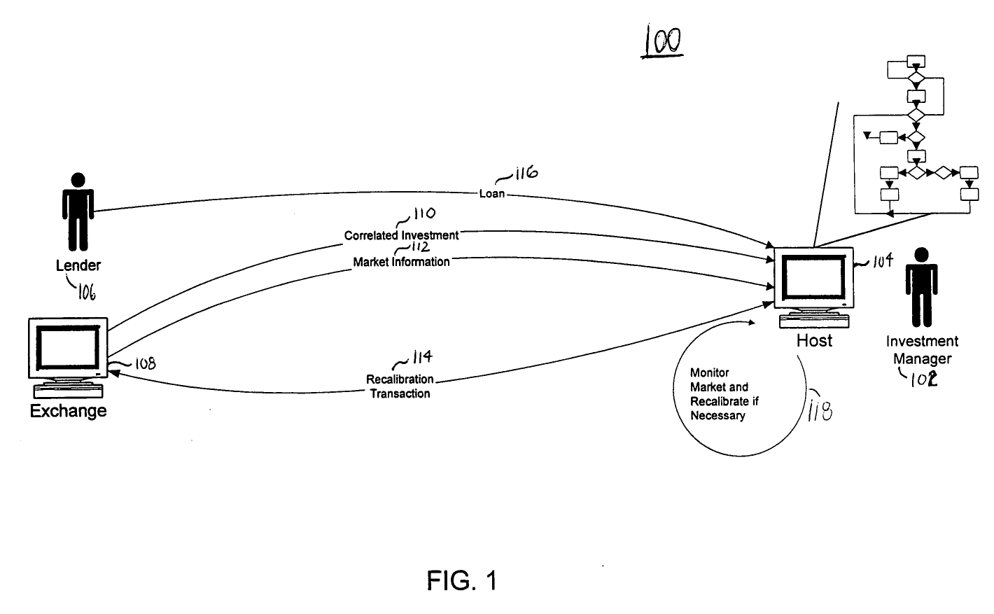

FIG. 1 is a collaboration diagram 100 of a correlated investment system in accordance with an exemplary embodiment of the present invention. An investment manager 102 may generate a correlated investment 110 with the aid of a computer system. In an exemplary embodiment, the investment manager 102 may use a host workstation 104 in communication with a lender 106 and an exchange 108. To generate the correlated investment 110, according to an exemplary embodiment, the investment manager 102 may determine a net asset value of the correlated investment 110 and may align the net asset value with a present value of a future liability. As the net asset value of the correlated investment 110 is aligned to the present value of the future liability, the net asset value of the correlated investment 110 may change in a highly correlated manner with changes in the present value of the future liability. Investment market information 112, may be generated by a securities exchange 108 or other similar market, and may be used to determine the present value of the future liability, such as, e.g., but not limited to, a bond.

The difficulty in applying this investment strategy may include maintaining a high degree of correlation between the present value of the future liability and the correlated net asset value of the correlated investment 110. To implement the strategy, a particular investment may be chosen that has the same duration as a future liability.

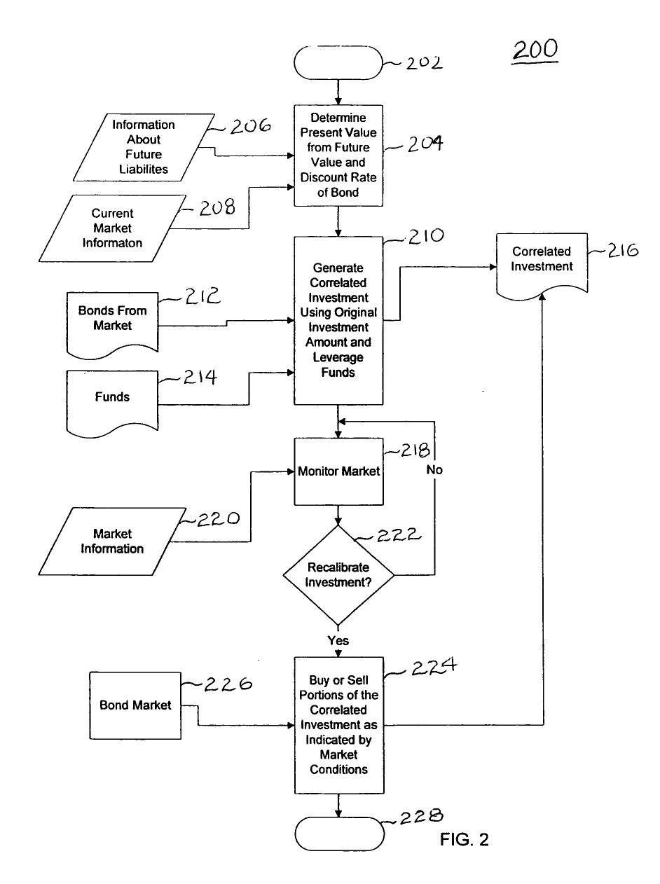

Referring now to FIG. 2 and FIG. 1, in the present invention, the goal of obtaining an investment having the same duration as a future liability may be accomplished by using a correlated investment 110, which may include a futures contract on a zero-coupon Treasury bond. FIG. 2 depicts a flow diagram 200, beginning with 202 and continuing immediately with 204 in an exemplary embodiment. In operation, in 204 the present value of a stream of future liabilities may be determined by discounting the future value of the future liabilities to a present value. The discount rate used to calculate the present value may be the yield of a zero-coupon Treasury bond which matures at substantially the same time that the future liabilities are due, as determined from future liability information 206. As such, the present value of the future liabilities will change with the yield on the matched zero-coupon Treasury bond. The yield of the zero-coupon Treasury bond may be determined from current bond market information 208.

To maintain the correlation with changes in the present value of the future liabilities, the futures contracts may be on zero-coupon Treasury bonds 212 of shorter duration than that of the future liabilities, but may be in greater amounts than the present value of the future liability. For example, in an exemplary embodiment, if the duration of a future liability is 20 years, a correlated investment 216 may be generated in 210 and could include, e.g., but not limited to, futures contracts on two 10-year zero-coupon Treasury bonds of the same face value. As the yield of the matched zero-coupon Treasury bond changes, the net asset value of the futures contracts may change at the same time and in the same direction, thus maintaining high correlation with the zero-coupon Treasury bond and therefore also maintaining high correlation with the present value of the future liability.

Since the correlated investment 216 has a shorter duration than the intended longer term investment, the correlated investment 216 may have a reduced change in value for a given change in yield of the zero-coupon Treasury bond. This means that the futures contracts should have a total present value amount larger than the present value of the future liability in order to match the rate of change of the intended longer term investment. To accomplish this, the correlated investment 216 may be leveraged by borrowing funds 214 to pay for the increased present value amount. Thus, in an exemplary embodiment, a loan 116 may be obtained from a lender 106, as shown in FIG. 1. In addition, the leveraged correlated investment may generate returns that are greater than the returns of a zero-coupon bond that matures at the same time the future liability is due.

For the investment to work properly, the present value of the correlated investment 216 may be, as shown in 218, monitored constantly by monitoring market information 220 about the bond market preferably a real-time computing system 300 may be used. As shown in FIG. 1, in an exemplary embodiment, market information 112 from exchange 108 may be accessed at host 104, and one or more recalibration transactions 114 may be undertaken. As shown in 118, the market may be monitored and recalibrated as necessary. If the present value changes significantly, as indicated in the futures markets by monitoring 218 market information 220, the investment may be easily recalibrated 220 as the correlated investment is very liquid. If it is determined in 222 that the investment is to be recalibrated, then in 224 portions of the correlated investment 216 may be bought or sold as indicated by market conditions as observed from the bond market 226. The market may be monitored 218 and recalibrated 220 as necessary.

The present invention can be used over a range of possible matched and semi-matched duration and leverage values. For example, in an exemplary embodiment, using the invention an investor may purchase a 20-year zero-coupon Treasury bond as the proxy for a 20 year future liability. Alternatively, in another exemplary embodiment, futures contracts on zero-coupon Treasury bonds of 15 years duration could also be purchased with a leverage factor of 1.33 to 1.

In addition to zero-coupon Treasury bonds this method of investment can use other securities and synthetic securities such as, e.g., but not limited to, separate trading of registered interest and principal of securities (“STRIPS”), promissory notes, loans, etc. In addition to bond futures of all types the present invention may be applied to other futures contracts that are related to interest rates or to interest-bearing securities. In addition, the invention may be applied to any future commitment situation, whether the commitment is specific or approximate as to amount and date.

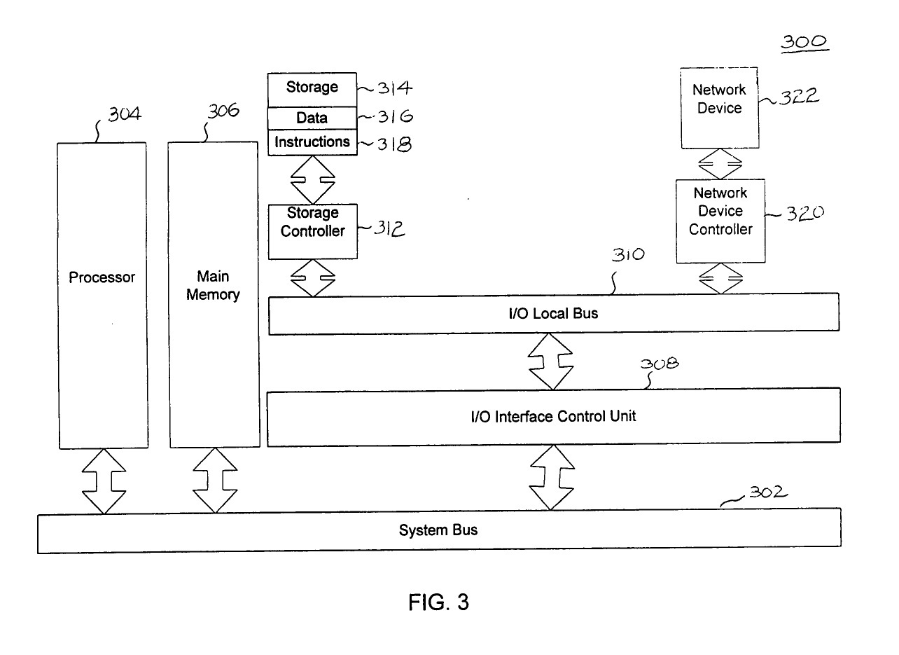

FIG. 3 is a block diagram 300 of a data processing apparatus suitable for hosting a correlated investment system 104 in accordance with an exemplary embodiment of the present invention. The data processing apparatus includes a processor 304 operably coupled to a main memory 306 by a system bus 302. The process may load programming instructions into the main memory 306. The programming instructions are executable by the processor 304 to implement the features of a correlated investment system as described herein.

The processor 304 may further be coupled to a storage device 314 through an Input/Output (I/O) control unit 308, an I/O local bus 310, and a storage device controller 312. The storage device may be used to store the programming instructions 318 and any data 316 used by the processor 304 to implement the features of a correlated investment system.

The processor 304 may further be coupled to a network device 322 via the Input/Output (I/O) control unit 308, the I/O local bus 310, and a communications device controller 320. The processor 304 may then communicate with other data processing systems, such as a data processing system 108 used to transmit bond market information or receive securities purchase requests, as desired to implement the features of a correlated investment system as described herein.

An exemplary embodiment of the invention may be implemented on computing device(s), processor(s) 304, computer(s) and/or communications device(s).

The computer, in an exemplary embodiment, may comprise one or more central processing units (CPUs) or processors, which may be coupled to a bus 302. The processor 304 may, e.g., access main memory 306 via the bus 302. The computer may be coupled to an input/output (I/O) subsystem 308 such as, e.g., but not limited to, a network interface (I/F) card (NIC) 322, or a modem for access to a network. The computer may also be coupled to a secondary memory 314 via I/O I/F 308 directly via bus (not shown), or via a main memory 306, for example. Secondary memory 314 may include, e.g., but not limited to, a disk storage unit or other storage medium. Exemplary disk storage units 314 may include, but are not limited to, a magnetic storage device such as, e.g., a hard disk, an optical storage device such as, e.g., a write once read many (WORM) drive, or a compact disc (CD), digital versatile disc (DVR), or a magneto optical device. Another type of secondary memory may include a removable disk storage device, which may be used in conjunction with a removable storage medium, such as, e.g. a CD-ROM, DVD-ROM, or a floppy diskette. In general, the disk storage unit may store an application program for operating the computer system referred to commonly as an operating system. The disk storage unit may also store documents of a database (not shown). The computer may interact with the I/O subsystems and disk storage unit via bus. The bus may also be coupled to a display for output, and input devices such as, but not limited to, a keyboard and a mouse or other pointing/selection device.

In this document, the terms “computer program medium” and “computer readable medium” may be used to generally refer to media such as, e.g., but not limited to removable storage drive, a hard disk installed in hard disk drive, and signals, etc. These computer program products may provide software to computer system. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supported by this application and the claims' equivalents rather than the foregoing description.

1. A computer system for generating a correlated investment comprising:
a host processor adapted to discount to present value one or more future liabilities at a discount rate of a bond that matures at the same time as said one or more future liabilities, and to generate a correlated investment using an original investment amount and leverage funds.

2. The computer system according to claim 1, wherein said host processor is further adapted to monitor market information about a bond market by communicating with an exchange computer, and to recalibrate said correlated investment according to said market information.

3. The computer system according to claim 2, wherein said host processor is further adapted to recalibrate said correlated investment comprising being adapted to at least one of buy or sell portions of said correlated investment as indicated by said market information.

4. The computer system according to claim 1, wherein said host processor is further adapted to generate returns from said correlated investment, wherein said returns are greater than returns of a zero-coupon bond that matures at a same time as said one or more future liabilities.

5. A computer-implemented method for generating a correlated investment comprising:
discounting to present value one or more future liabilities at a discount rate of a bond that matures at the same time as said one or more future liabilities;
generating a correlated investment using an original investment amount and leverage funds;
monitoring market information about a bond market using a computer;
recalibrating said correlated investment using said computer according to said market information comprising:
recommending at least one of buying or selling portions of said correlated investment as indicated by said market information.

6. The method according to claim 5, further comprising:
generating returns from said correlated investment, wherein said returns are greater than returns of a zero-coupon bond that matures at a same time as said one or more future liabilities.

7. A computer-implemented method for generating a correlated investment comprising:
aligning a net asset value of a correlated investment with a present value of a future liability comprising matching a duration of said correlated investment to a duration of said future liability; and
changing the net asset value of said correlated investment in a highly correlated manner with a change in the present value of said future liability.

8. The method according to claim 7, further comprising:
generating returns from said correlated investment, wherein said returns are greater than returns of a zero-coupon bond that matures at a same time as completion of the duration of said future liability.

9. The method according to claim 7, wherein said changing comprises:
monitoring market information; and
recalibrating said correlated investment based on said market information.

10. The method according to claim 7, wherein said future liability comprises a stream of one or more future liabilities.

11. The method according to claim 7, wherein said aligning comprises:
discounting a future value of the said future liability to a present value using a discount rate.

12. The method according to claim 11, wherein said discounting by said discount rate comprises discounting by a rate equal to a yield of a zero-coupon Treasury bond, said Treasury bond maturing at a same time as said future liability.

13. A computer program product embodied on a computer readable media, the product adapted to enable a computer processor to perform a method for generating a correlated investment, said method comprising:
discounting to present value one or more future liabilities at a discount rate of a bond that matures at the same time as said one or more future liabilities;
generating a correlated investment using an original investment amount and leverage funds;
monitoring market information about a bond market using a computer;
recalibrating said correlated investment using said computer according to said market information comprising:
recommending at least one of buying or selling portions of said correlated investment as indicated by said market information.

14. The computer program product according to claim 13, wherein the method further comprises:
generating returns from said correlated investment, wherein said returns are greater than returns of a zero-coupon bond that matures at a same time as completion of the duration of said future liability.

15. The computer program product according to claim 13, wherein said changing of the method comprises:
monitoring market information; and
recalibrating said correlated investment based on said market information.

16. The computer program product according to claim 13, wherein said future liability comprises a stream of one or more future liabilities.

17. The computer program product according to claim 13, wherein said aligning of the method comprises:
discounting a future value of the said future liability to a present value using a discount rate.

18. The computer program product according to claim 17, wherein said discount rate comprises a yield of a zero-coupon Treasury bond, said Treasury bond maturing at a same time as said future liability.

19. A system for generating a correlated investment comprising:
means for discounting to present value one or more future liabilities at a discount rate of a bond that matures at the same time as said one or more future liabilities;
means for generating a correlated investment using an original investment amount and leverage funds;
means for monitoring market information about a bond market using a computer;
means for recalibrating said correlated investment using said computer according to said market information comprising:
means for recommending at least one of buying or selling portions of said correlated investment as indicated by said market information.

20. A system adapted to generate a correlated investment comprising:
a host computer adapted to discount to present value one or more future liabilities at a discount rate of a bond that matures at the same time as said one or more future liabilities, to generate a correlated investment using an original investment amount and leverage funds, to monitor market information about a bond market, to recalibrate said correlated investment according to said market information, by being adapted to at least one of buy or sell portions of said correlated investment as indicated by said market information.
